(19) United States
(12) Patent Application Publication
(10) Pub. No.: US 2024/0174158 A1
(43) Pub. Date: May 30, 2024

(54) TRAILER FOR TRANSPORTING MACHINERY FOR BUNDLING AND WRAPPING CABLES

(71) Applicant: Torrance Clayne Bistline, Hildale, UT (US)

(72) Inventor: Torrance Clayne Bistline, Hildale, UT (US)

(21) Appl. No.: 18/059,336

(22) Filed: Nov. 28, 2022

(51) Int. Cl. B60P 3/035

(52) U.S. Cl. CPC B60P 3/035

(57) ABSTRACT

A trailer is provided for transporting machinery for bundling and wrapping cables. The trailer can include rails that are configured to receive a cable support. The trailer can also include a cage that is positioned above the rails and configured to support a cable wrapping machine.

### CROSS-REFERENCE TO RELATED APPLICATIONS

N/A

### BACKGROUND

When cables are installed in trenches, such as at wind or solar farms, they are often bundled together to ensure they remain grouped. Traditionally, this bundling was accomplished with zip-ties. Recently, Applicant invented a self-propelled cable wrapping machine that bundles the cables by wrapping them with twine as described in U.S. Pat. No. 11,292,627 (the “'627 Patent”). During use, the cable wrapping machine of the '627 Patent is typically placed on a flatbed trailer that carries the reels of cable. The ends of the cables can be anchored so that, as the truck and trailer drive forward, the cables are pulled through the cable wrapping machine and bundled. Due to its size, the cable wrapping machine can be difficult to transport such as between job sites.

### BRIEF SUMMARY

The present invention extends to a trailer for transporting machinery for bundling and wrapping cables. The trailer can include rails that are configured to receive a cable support. The trailer can also include a cage that is positioned above the rails and configured to support a cable wrapping machine.

In some embodiments, the present invention is implemented as a trailer for transporting machinery for bundling and wrapping cables. The trailer can include a frame, rails that are supported from the frame, the rails being spaced to correspond with a cable support, and a cage that is supported from the frame, the cage being spaced above the rails and being configured to support a cable wrapping machine.

In some embodiments, the frame may include cross supports on which the rails are supported.

In some embodiments, the trailer may include wheels for supporting the frame off the ground.

In some embodiments, each rail may have an open rear end and a closed front end.

In some embodiments, the cage may be supported from the frame by mounting members.

In some embodiments, the mounting members may comprise sleeves for receiving legs of the cage.

In some embodiments, a height of the cage relative to the rails may be adjustable.

In some embodiments, the cage may comprise cross members.

In some embodiments, the cross members may extend between opposing legs of the cage.

In some embodiments, the cage may comprise middle support members that extend between the cross members.

In some embodiments, the cross members and the middle support members may define a shape that corresponds with a shape of a frame base of the cable wrapping machine.

In some embodiments, the shape may be a rectangle.

In some embodiments, the cage may comprise front support members.

In some embodiments, the front support members may be spaced to correspond with a width of a front extension of the cable wrapping machine.

In some embodiments, the trailer may include one or more coupling members for securing the front extension to the front support members.

In some embodiments, the present invention may be implemented as a trailer for transporting machinery for bundling and wrapping cables. The trailer may include a frame having wheels, rails that are supported from the frame, the rails being spaced to correspond with a cable support, and a cage that is supported from the frame. The cage may be spaced above the rails to thereby enable the cable support to be positioned below the cage. The cage may be configured to support a cable wrapping machine placed on top of the cage.

In some embodiments, each rail may have an open rear end and a closed front end.

In some embodiments, the cage may comprise cross members that extend between opposing legs of the cage, middle support members that extend between the cross members, and front support members.

In some embodiments, the cross members and the middle support members may align with a frame base of the cable wrapping machine.

In some embodiments, the present invention may be implemented as a trailer for transporting machinery for bundling and wrapping cables. The trailer may include a frame having rails and a cage, a cable support positioned on the rails and below the cage, and a cable wrapping machine positioned on top of the cage.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIG. 1 is a perspective view of a trailer that is configured in accordance with one or more embodiments of the present invention;

FIG. 2 is a side view of the trailer of FIG. 1;

FIG. 3 is a perspective view of the trailer of FIG. 1 with a cage removed;

FIG. 4 is a perspective view of the trailer of FIG. 1 when the trailer is transporting machinery for bundling and wrapping cables;

FIG. 5 is a side view of the trailer of FIG. 1 when the trailer is transporting machinery for bundling and wrapping cables;

FIG. 6 is an example of machinery for bundling and wrapping cables that may be transported on the trailer of FIG. 1; and

FIG. 7 is an example of machinery for bundling and wrapping cables that may be transported on the trailer of FIG. 1.

### DETAILED DESCRIPTION

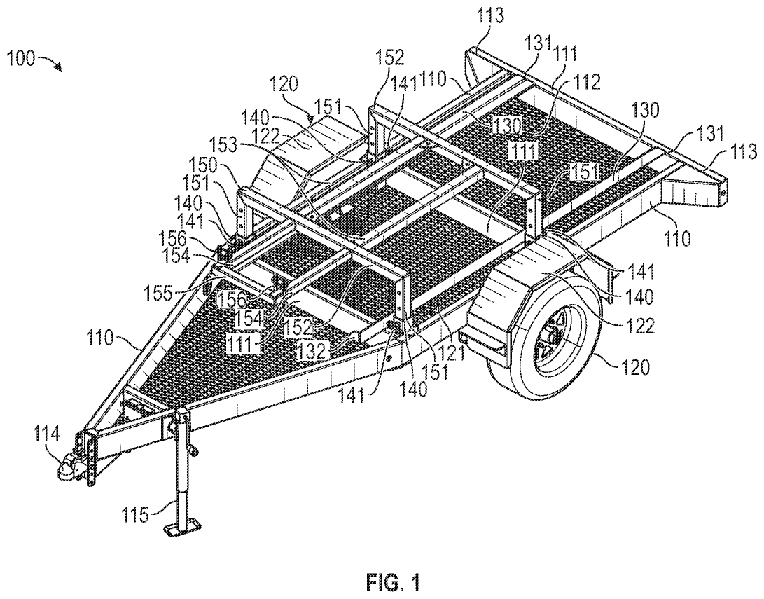

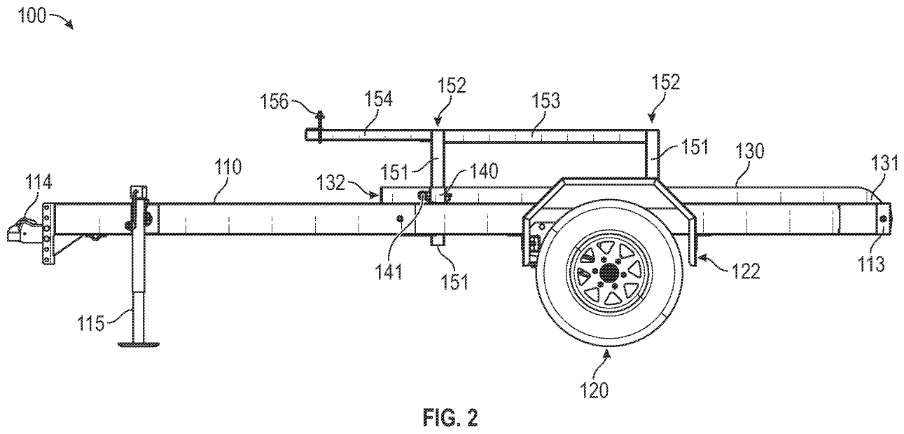

FIGS. 1 and 2 are perspective and side views respectively of a trailer 100 that is configured in accordance with one or more embodiments of the present invention. Trailer 100 includes a frame 110 having cross supports 111, a mesh floor 112, lights 113, a coupler 114, a jack 115, wheels 120 and fenders 121. Accordingly, trailer 100 can be connected to any vehicle having a hitch ball. However, trailer 100 could be configured to couple to a vehicle in any other suitable manner. Also, in some embodiments, trailer 100 (or its components) could be integrated into a vehicle as opposed to being pulled by the vehicle, such as by integrating trailer 100 into a flatbed truck.

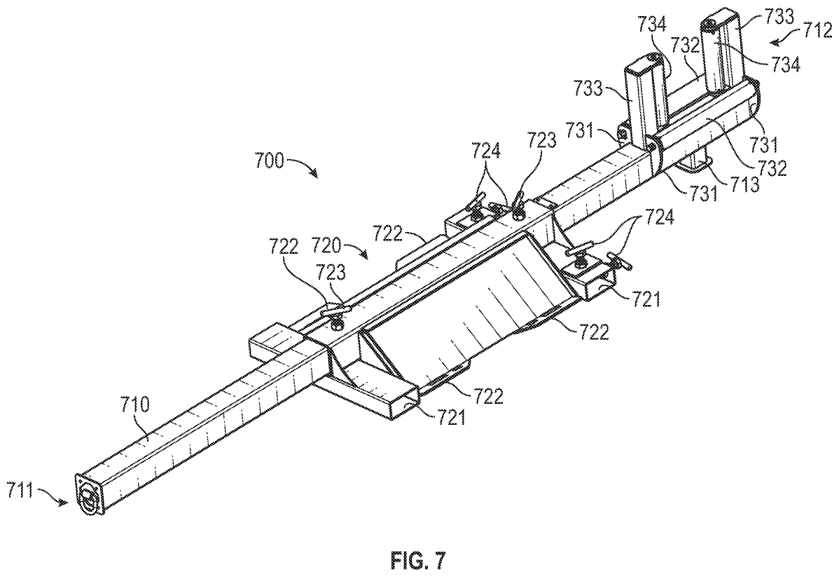

Trailer 100 includes opposing rails 130 that are positioned on top of and supported by cross supports 111. A rear end 131 of each rail 130 is open, while a front end 132 of each rail 130 is closed. As described in greater detail below, rails 130 can be spaced apart to accommodate and secure a cable support such as the cable support shown in FIG. 7.

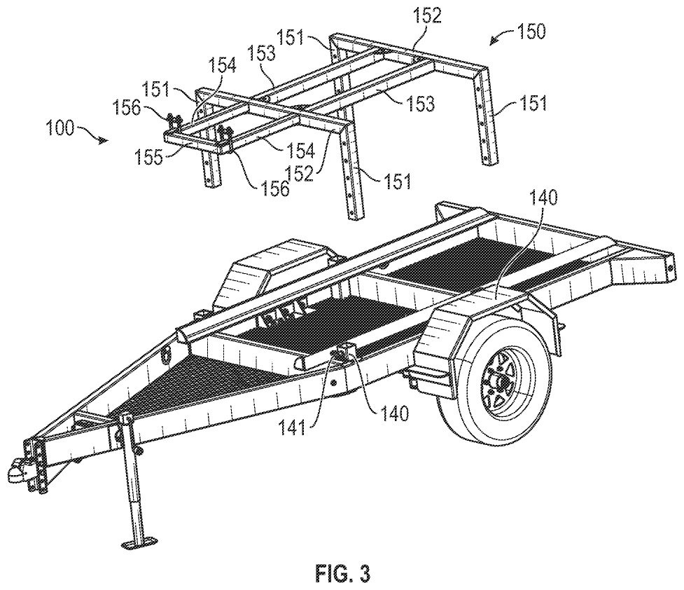

Trailer 100 also includes mounting members 140 that are secured to frame 110 and configured to receive a cage 150 which is shown removed from trailer 100 in FIG. 3. For example, mounting members 140 may be in the form of sleeves for receiving cage 150 and may include one or more pins 141 for retaining cage 150 at a desired height relative to rails 130. In the depicted embodiment, trailer 100 includes four mounting members 140 arranged in a rectangular pattern.

Cage 150 includes legs 151 that correspond with mounting members 140 to allow cage 150 to be secured to frame 110. Legs 151 may include holes for allowing cage 150 to be positioned at different heights using pins 141. Cage 150 also includes cross members 152 that extend between opposing pairs of legs 151. Cage 150 further includes middle support members 153 that extend between cross members 152 and front support members 154 that extend frontwardly from a frontward cross member 152 and are aligned with middle support members 153. A reinforcement member 155 may extend between front support members 154. Coupling members 156 may be selectively secured around front support members 154.

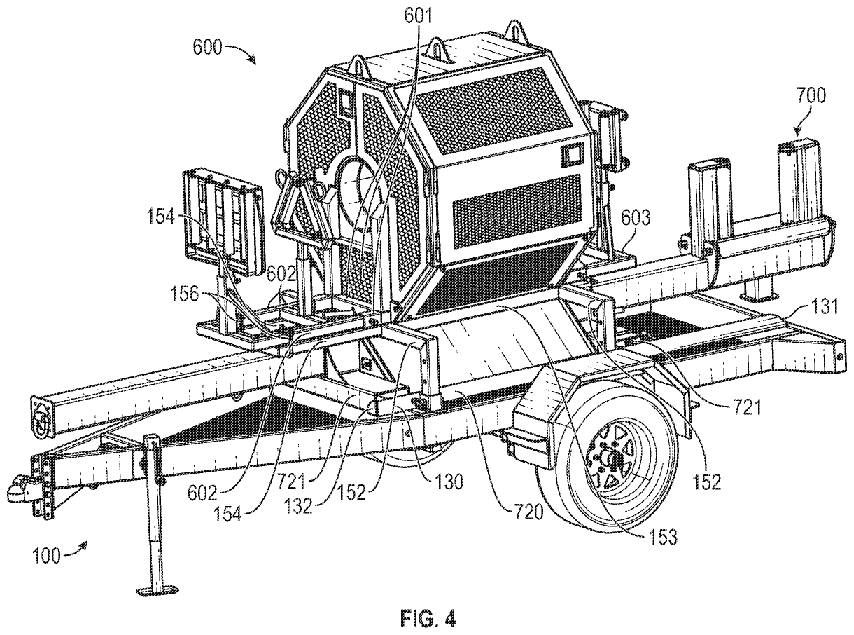

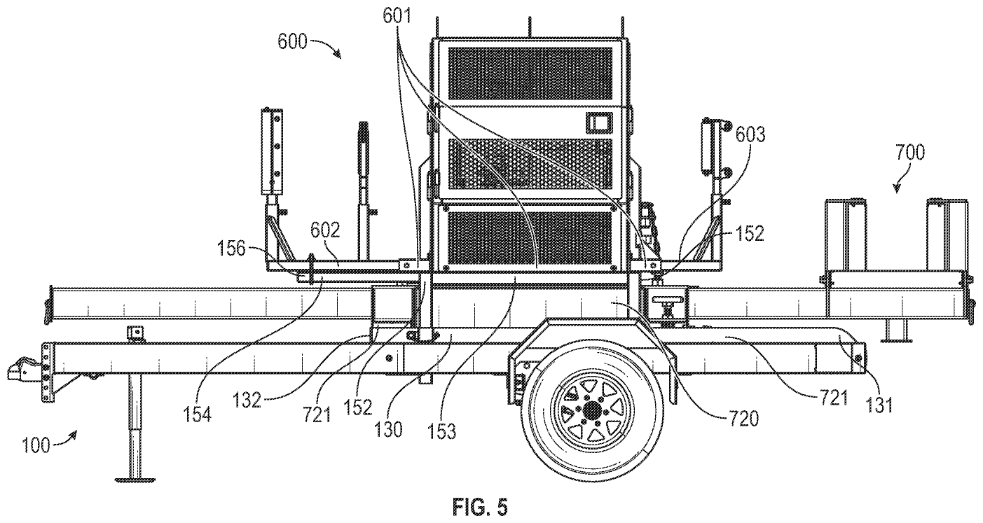

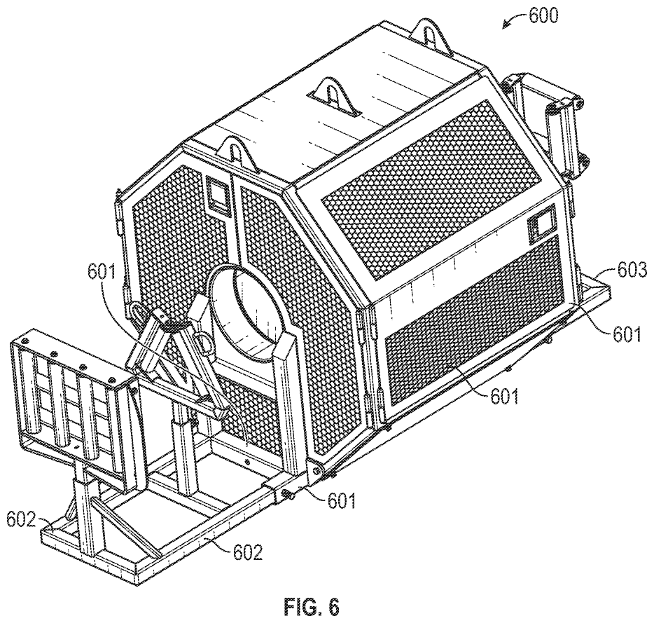

FIGS. 4 and 5 are perspective and side views respectively of trailer 100 when used to transport a cable wrapping machine 600 and a cable support 700. FIGS. 6 and 7 show cable wrapping machine 600 and cable support 700 respectively in isolation.

Cable wrapping machine 600 includes a frame base 601 having a generally rectangular shape, a front extension 602 that extends frontwardly from and in line with frame base 601, and a rear extension 603 that extends rearwardly from and in line with frame base 601. Cable wrapping machine 600 could correspond with the cable wrapping machine of the '627 Patent.

Cable support 700 includes an arm 710 having a first end 711 and a second end 712, a mounting interface 720 that is slidable attached to arm 710 and configured to allow cable support 700 to be mounted to a forklift or loader (e.g., a Skid Steer), and a cable guide 730 that is positioned at second end 712.

Mounting interface 720 includes fork receivers 721 that are positioned perpendicular to arm 710 and extend from opposing sides of arm 710 to allow cable support 700 to be carried by a forklift in a left or right orientation. Mounting interface 720 also includes mounting plates 722 on each side of arm 710 to allow cable support 700 to be carried by a loader in a left or right orientation. Mounting plates 722 could be Skid Steer universal mounting plates. Mounting interface 720 can include tightening members 723 to allow mounting interface 720 to be tightened onto arm 710 at a desired position. Fork receivers 721 may also include tightening members 724 to allow fork receivers 721 to be tightened onto one or both forks of a forklift. A stand 713 may extend downwardly from second end 712 the same or similar distance as fork receivers 721 so that cable support 700 is level when placed on a flat surface.

Cable guide 730 includes opposing horizontal rollers 732 that extend between flanges 731 and opposing vertical rollers 734 that are mounted to vertical supports 733 between horizontal rollers 732. Cables that have been wrapped using cable wrapping machine 600 can be positioned on horizontal rollers 732 and between vertical rollers 734 and cable support 700 can then be maneuvered overtop a trench or other intended location for the bundled cables to facilitate placement of the bundled cables. For example, a forklift or loader carrying cable support 700 can be driven behind a trailer (including trailer 100) carrying cable wrapping machine 600 to direct the bundled cables into a trench.

With reference to FIGS. 4 and 5, rails 130 on trailer 100 can be spaced apart to correspond with the width of fork receivers 721. Therefore, cable support 700 can be stored on trailer 100 by sliding fork receivers 721 onto rails 130 past open rear ends 131 until the frontward fork receiver 721 contacts closed front ends 132 of rails 130. The outer walls of rails 130 can prevent cable support 700 from sliding side to side during transport. Cage 150 can be positioned at a height relative to rails 130 that allows cable support 700 to slide underneath cage 150.

Cable wrapping machine 600 can be placed on top of cage 150. Cross members 152 can be spaced apart to correspond with the depth (or longer dimension) of frame base 601 of cable wrapping machine 600, and middle support members 153 can be spaced apart to correspond with the width (or shorter dimension) of frame base 601 of cable wrapping machine 600. Front support members 154 can be spaced apart to correspond with the width of front extension 602 of cable wrapping machine 600. Accordingly, with cable wrapping machine 600 positioned on cage 150, frame base 601 can align with cross members 152 and middle support members 153, and front extension 602 can align with front support members 154. Coupling members 156 can then be secured around front extension 602 and front support members 154 to secure cable wrapping machine 600 to cage 150.

Trailer 100 can be used to transport cable wrapping machine 600 and cable support 700 such as between job sites. Also, in some cases, trailer 100 can be used to carry cable wrapping machine 600 during operation. For example, trailer 100 could be hitched to and towed behind a reel trailer as opposed to placing cable wrapping machine 600 on the reel trailer.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A trailer for transporting machinery for bundling and wrapping cables comprising:
a frame;
rails that are supported from the frame, the rails being spaced to correspond with a cable support; and
a cage that is supported from the frame, the cage being spaced above the rails and being configured to support a cable wrapping machine.

2. The trailer of claim 1, wherein the frame includes cross supports on which the rails are supported.

3. The trailer of claim 1, further comprising:
wheels for supporting the frame off the ground.

4. The trailer of claim 1, wherein each rail has an open rear end and a closed front end.

5. The trailer of claim 1, wherein the cage is supported from the frame by mounting members.

6. The trailer of claim 5, wherein the mounting members comprise sleeves for receiving legs of the cage.

7. The trailer of claim 5, wherein a height of the cage relative to the rails is adjustable.

8. The trailer of claim 1, wherein the cage comprises cross members.

9. The trailer of claim 8, wherein the cross members extend between opposing legs of the cage.

10. The trailer of claim 8, wherein the cage comprises middle support members that extend between the cross members.

11. The trailer of claim 10, the cross members and the middle support members define a shape that corresponds with a shape of a frame base of the cable wrapping machine.

12. The trailer of claim 11, wherein the shape is a rectangle.

13. The trailer of claim 10, wherein the cage comprises front support members.

14. The trailer of claim 13, wherein the front support members are spaced to correspond with a width of a front extension of the cable wrapping machine.

15. The trailer of claim 14, further comprising:
one or more coupling members for securing the front extension to the front support members.

16. A trailer for transporting machinery for bundling and wrapping cables comprising:
a frame having wheels;
rails that are supported from the frame, the rails being spaced to correspond with a cable support; and
a cage that is supported from the frame, the cage being spaced above the rails to thereby enable the cable support to be positioned below the cage, the cage being configured to support a cable wrapping machine placed on top of the cage.

17. The trailer of claim 16, wherein each rail has an open rear end and a closed front end.

18. The trailer of claim 17, wherein the cage comprises cross members that extend between opposing legs of the cage, middle support members that extend between the cross members, and front support members.

19. The trailer of claim 18, wherein the cross members and the middle support members align with a frame base of the cable wrapping machine.

20. A trailer for transporting machinery for bundling and wrapping cables comprising:
a frame having rails and a cage;
a cable support positioned on the rails and below the cage; and
a cable wrapping machine positioned on top of the cage.
